(19) United States
(12) Patent Application Publication
(10) Pub. No.: US 2006/0233209 A1
(43) Pub. Date: Oct. 19, 2006

(54) Solid body

(76) Inventor: Todor Kirilov, Geltru (ES)

Correspondence Address: SHLESINGER, ARKWRIGHT & GARVEY LLP, Suite 600, 1420 King Street, Alexandria, VA, 22314, US

(21) Appl. No.: 11/311,636

(22) Filed: Dec. 20, 2005

Related U.S. Application Data
(63) Continuation of application No. PCT/EP04/03098, filed on Mar. 24, 2004.

(30) Foreign Application Priority Data
Jun. 20, 2003 (DE) 103 28 115.0-11
Nov. 26, 2003 (DE) 103 55 216.2-54

(51) Int. Cl. H01S 3/14

(52) U.S. Cl. 372/39

(57) ABSTRACT

Solid body for the production of solid-state lasers, the solid body having, at least in an optically used area, monoclinic elementary cells based on the same crystallographic system of coordinates, and having in the optically used area at least two domains with different chemical compositions, the optically used area having at least one active zone and at least one non-active zone. At least in the optically used area, at least one of tungstenate, potassium, and rubidium may be a constituent of the monoclinic elementary cells. At least in the optically used area, at least one of Y, Sm, Eu, Gd, Tb, Dy, Ho, Er, Tm, Yb, and Lu may be a constituent of the monoclinic elementary cells. Solid body is suited for a device for generating coherent electromagnetic radiation, such as a laser beam. The solid body may be used as a disk or chip laser.

### CROSS-REFERENCE TO RELATED APPLICATIONS

This application is a continuation of application no. PCT/EP2004/003098, filed Mar. 24, 2004, which claims the priority of German application no. 103 55 216.2, filed 26 Nov. 2003, and which claims the priority of German application no. 103 28 115.0, filed 20 Jun. 2003, and each of which is incorporated herein by reference.

### FIELD OF THE INVENTION

The invention relates to solid bodies. More particularly, the invention relates to a solid body for the production of solid-state lasers. Even more particularly, the invention relates to a solid body for the production of solid-state lasers, the solid body having, at least in an optically used area, monoclinic elementary cells based on the same crystallographic system of coordinates, and having in the optically used area at least two domains which differ with respect to their chemical compositions, the optically used area having at least one active zone and at least one non-active zone.

### BACKGROUND OF THE INVENTION

For the production of solid-state lasers solid bodies in the form of crystals including garnet (YAG), vanadate (YVO), fluoride (YLF), sapphire (Sa), and glass may, for example, may be used. Ions are introduced into these crystals as doping for example, whereby the concentration of these ions is greater, as compared to a gas laser, so that greater energy output may be obtained with solid-state lasers. Elements that are suitable for yielding doping ions include, for instance, those that are chemically similar to the crystal being used. Consequently, many of the crystals used for solid-state lasers contain yttrium (Y), which can be easily replaced by ions of rare earths. Thirteen elements are designated as rare earths, viz., cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). When present in a crystal as doping ions these ions are usually in trivalent form.

A significant characteristic when selecting crystals for solid-state lasers is their ability to conduct heat, because a substantial share of the excitation energy is converted to heat. A non-homogenous temperature distribution in the crystal can result in a change of the refractive index, which can cause lens effects and sensitively change the resonance characteristics of the solid-state laser.

The most important solid-state laser is the neodymium laser, in which the laser beam is generated by Nd³⁺ ions. In such a laser the Nd³⁺ ion is often introduced into a YAG crystal, which has high optical amplification as well as suitable mechanical and thermal characteristics. Consequently, such YAG crystals can be used for both continuous emission lasers and pulsed lasers. A significant disadvantage of Nd:YAG crystals, for example, is the strong double refraction that occurs in varying degrees over the cross section of the crystal as a result of excitation heating. The laser beam becomes polarized by this double refraction and the beam quality of high-performance lasers is greatly degraded. This requires the use of polarization retaining crystals.

However, the use of such polarization retaining crystals or adaptive layers between the pump source and the crystal results in limitation of the laser's output, because a total inner reflection of spontaneous emissions (ASE) occurs on the boundary surfaces, which results in undesirable heating of the crystal.

Another material that may be used for solid-state lasers is glass, for example, silica or phosphate glass, which can, for example, be doped with Nd³⁺ ions. It is possible to use more ions to dope such glasses and they are consequently used for high-performance Nd laser systems.

The prior art includes the use of tungstenates as crystals for the production of laser materials, in which the raw material is, for example, doped with rare earth ions.

Ytterbium (Yb), for example, is known to be a suitable doping material for the production of solid-state lasers with beams in the micrometer range. Such a laser can, for example, be excited by means of an indium gallium arsenite laser diode with a wavelength of 0.9 to 1 μum, such that even simple energy sources such as diodes with wavelengths of 965 or 980 nm can be used to excite the crystal. Doping with Ytterbium (Yb) offers significant advantages over doping with neodymium (Nd). A particular advantage consists of the relatively small laser quantum effect, which results in less heat being developed in the crystal. In addition, the very large absorption coefficient permits the use of thin crystal layers.

When the crystal thickness is reduced, the phase deviation between two neighboring longitudinal modes becomes so small that the spatial hole burning effect does not occur. This results in single frequency beaming.

On the other hand, however, the thickness of the crystal must be sufficiently great as to absorb a sufficient share of the excitation energy. In this regard the minimal thickness necessary for such an operation is a function of the level to which the crystal is doped. For doping in the order of magnitude of 1.4×10²¹ cm⁻³; thicknesses of less than 100 μm can be achieved.

Crystals that are less than 100 μm in thickness are not easily handled during production so that the production of high-performance lasers with this kind of crystals is very effort and time consuming and thus expensive.

### OBJECTS AND SUMMARY OF THE INVENTION

An object of the invention is to overcome the drawbacks of the prior art.

Another object of the invention is to provide a solid body that in particular makes it possible to produce high-performance lasers easily and economically.

This object is achieved by the inventive solid body for the production of solid-state lasers, the solid body having, at least in an optically used area, monoclinic elementary cells based on the same crystallographic system of coordinates, and having in the optically used area at least two domains which differ with respect to their chemical compositions, the optically used area having at least one active zone and at least one non-active zone.

Advantageous and practical advanced developments on the inventive concept are set forth below.

In accordance with the invention the term optically used area refers to the area of the solid body used for the particular optical application. Thus, for example, if the solid body forms a laser, the optically used area is that area which, for example, is covered by the pump beam of a pump source and/or through which a generated laser beam passes.

As defined by the invention a domain refers to an area of a chemically defined composition that includes at least one elementary cell.

In accordance with the invention the term an active zone refers to an area during an optical application in which optical absorption of the particular wavelength range takes place. In a non-active zone, on the other hand, no absorption of the particular wavelength range takes place.

In accordance with the invention the inventive crystal may have a crystalline structure, whereby, for example, an initial active domain can be imposed on a second non-active domain by a suitable procedure.

More than two domains can be provided in accordance with particular requirements.

If both domains include the same raw material, the result in accordance with the invention is that the solid body includes monoclinic elementary cells, by which the solid body has substantially the same crystallographic system of coordinates in each location of the optically used area.

However, it is also possible in accordance with the invention to produce as separate elements including monoclinic elementary cells the at least two domains envisioned by the invention, whereby the domains are connected in accordance with the invention such that substantially the same crystallographic system of coordinates exists at each location in an optically used area of the solid body.

It is also possible in accordance with the invention to produce the two domains from suitable raw materials which nevertheless differ from one another with respect to their chemical composition, provided that in accordance with the invention it is assured that the solid body comprised of at least two domains includes monoclinic elementary cells, whereby substantially the same crystallographic system of coordinates exists at each location in an optically used area of the solid body.

Preferably one of the domains forms a laser active zone while the other domain forms a passive, i.e., non-active, zone. In this regard the laser effect takes place in the laser active zone while the passive zone can serve as the mount for the laser active zone. For example, the passive zone can form a spacer for establishing a pre-determined distance between the laser active zone and a pump source.

A special advantage of the inventive concept derives from the fact that when used as a laser the inventive solid body can be directly connected to a pump source without the necessity of expensive adaptive layers or adaptive optics between the pump source and the solid body. It is, for example, possible to fasten the laser active zone directly to the pump source by a suitable selection of the thickness of the passive domains in the pump source beam direction, whereby the thickness of the passive domains is selected such that the diverging pumped beam from the pump source has in the desired manner a substantially circular beam profile in the area of the laser active domains.

A particular advantage deriving from the use of potassium-ytterbium-tungstenate (hereinafter: KYbW) is that the absorption length at about 13.3 μm at 980 nm is extremely short. Another special advantage of KYbW is that the laser quantum defect is very small.

The invention is explained in greater detail with the aid of the attached schematic diagrams, in which examples of embodiments of an inventive solid body are presented.

Relative terms such as left, right, up, and down are for convenience only and are not intended to be limiting.

### BRIEF DESCRIPTION OF THE DRAWINGS

FIG. 1 is a near field region and a far field region beam characteristic of a typical diode laser used as pump source,

FIG. 2 is a partial view of a state of the art laser located inside a housing,

FIG. 3 is a schematic cross section through a first embodiment of an inventive solid body in the form of a laser,

FIG. 4 is a second embodiment of an inventive solid body in the form of a laser, shown in the same manner as in FIG. 3,

FIG. 5 is a third embodiment of an inventive solid body in the form of a wave guide, shown in the same manner as in FIG. 3,

FIG. 6 is a fourth embodiment of an inventive solid body in the form of a wafer or disk laser, shown in the same manner as in FIG. 3,

FIG. 7 is a fifth embodiment of an inventive solid body in the form of a Bragg reflector, shown in the same manner as in FIG. 3,

FIG. 8 is a schematic sectional view of an embodiment of an inventive short pulse laser, and

FIG. 9 is a schematic sectional view of an embodiment of an inventive regenerative amplifier.

### DETAILED DESCRIPTION OF THE INVENTION

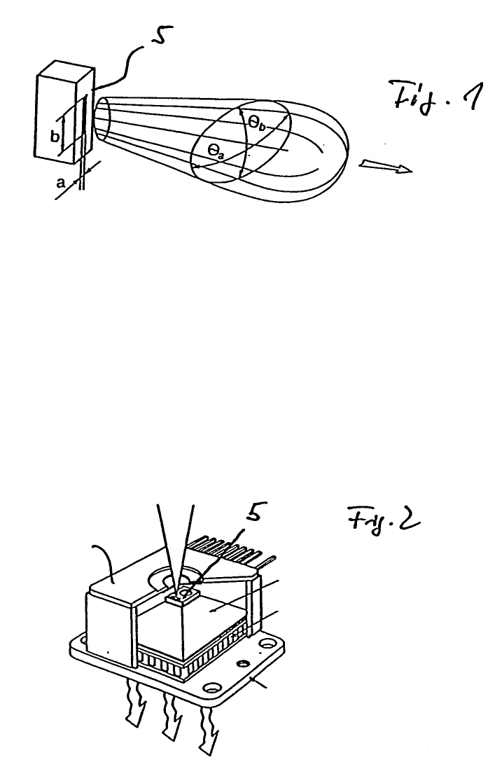

Reference will now be made to FIGS. 1 through 3.

FIG. 1 depicts the near field and far field beam characteristics of a diode laser serving as a pump source. As may be seen from FIG. 1 the pump source has a diverging beam profile, in which the beam profile is almost circular at a predetermined distance from the pump source.

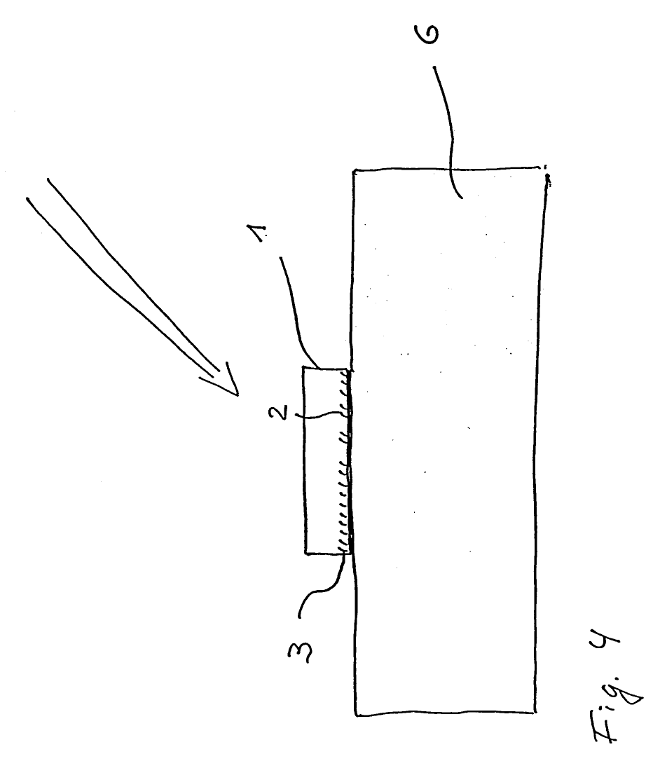

FIG. 3 depicts a first embodiment of an inventive solid body, which in this embodiment has a first domain 1 and a second domain 2, and which in this embodiment form a mono-crystalline structure. The first domain 1 forms in this embodiment a passive domain and consists of potassium-yttrium-tungstenate, while the second domain 2 forms a laser active domain and consists of potassium-ytterbium-tungstenate.

The solid body has reflector layers on its upper side 4 and its lower side 3 whose purpose is to form a laser resonator.

The inventive solid body can be pumped with a conventional laser diode 5 without additional adaptive optics and used as a laser. As depicted in FIG. 1 the beam of the laser diode 5, which serves to pump the laser active domain 2, is divergent and the cross section of the beam is elliptically shaped. However, the beam characteristic of the near field region is different from that of the far field region, whereby divergence angles of approximately 30° are common. Because of diffraction effects the beam's divergence is greatest in an area perpendicular to the diode's PN junction. At a greater distance from the PN junction, in the far field region, the beam again becomes elliptical, in this case with its longitudinal axis being perpendicular to the PN junction. At a distance of approximately 275 μm from the PN junction between the near field region and the far field region the pumped beam has a substantially circular cross section.

The inventive solid body can be attached directly to the laser diode 5 or can be mounted adjacent to the laser diode 5, thus in an area in which the beam cross section of the laser diode 5 is substantially circular. The passive domain 1 faces toward the laser diode 5, while laser active domain 2 faces away from the laser diode 5. The distance between the laser diode 5 and the laser active domain 2 is consequently selected such that the beam of the laser diode 5 has a substantially circular beam cross-section as it enters the laser active domain 2. Because of the extremely short absorption length of the laser active domain the deviations of the beam cross section from the desired circular beam cross section along the laser active domain 2 have no practical effects.

An additional advantage of the arrangement depicted in FIG. 3 is the fact that the thermal stresses induced in the solid body are reduced by the beam divergences of the laser diode 5.

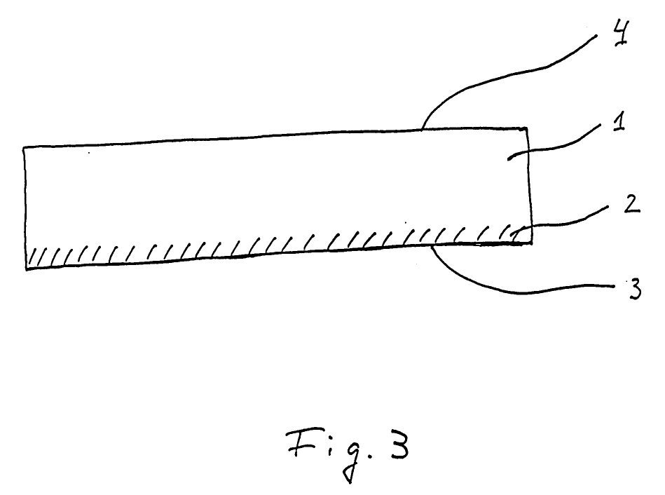

In this way the inventive solid body can—in lieu of a window which as depicted in FIG. 2 commonly serves as a protection from dust in conventional lasers—be directly combined with the laser diode 5, which serves to pump the laser active domains 2. In this regard, the passive domain in this embodiment serves mainly as the mechanical mount for the laser active domains. In addition, the passive domain can also serve as a spacer between the laser active domains 2 and the laser diode 5 for the purpose of maintaining the proper distance between the laser diode 5 and the laser active domain 2 such that the substantially circular beam cross section of the pump beam in the laser active domain 2 is achieved.

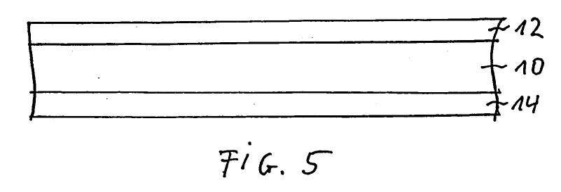

FIG. 4 depicts a second embodiment of an inventive solid body in the form of a laser that has a first passive domain 1 and a second active, here laser active, domain 2 that is connected to a mount 6. The laser active domain of this embodiment is about 50 μm thick, whereby a laser diode (not shown) is used for pumping. In this embodiment the laser active domain 2 is doped with ytterbium and additionally with up to 10 % Thulium (Tm). Owing to this combined doping with Ytterbium (Yb) and Thulium (Tm), excitation with a wavelength of 900 to 1000 nm is possible, whereby the laser beam has a wavelength of 2 μm.

FIG. 5 depicts a third embodiment of an inventive solid body which has a first domain 10 having a thickness of about 40 μm and is made of KYbW, which is doped with 1 at-% Nd. Domain 10 is located between the two domains 12 and 14, which are made of potassium-yttrium-tungstenate (KYW). Because the refractive index of KYW is smaller than the refractive index of KYbW, domain 10 forms a wave guide. The solid body depicted in FIG. 5 can, for example, be used in conjunction with a chip laser, which emits at 1.4 μm.

One of the two domains 12 and 14 is formed particularly thin in order to reduce the thermal resistance. Absorption of the pump beam is transmitted quasi-resonantly to the Nd. The resonator reflectors are conductive at 1.06 μm and are at the second laser junction highly reflective at 1.35 μm.

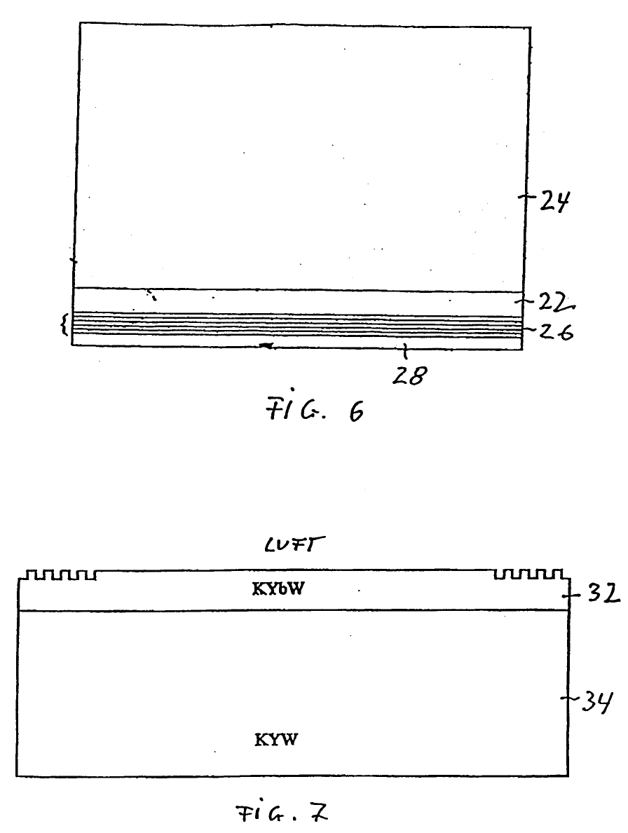

FIG. 6 depicts an additional embodiment of an inventive solid body, which in this embodiment forms a high-performance disk laser. The solid body of this embodiment has a laser active first domain 22, which in this embodiment consists of KYbW. In addition the solid body has a second domain 24 that is connected to the first domain 22, and which second domain 24 is passive in this embodiment and consists of potassium-lutetium-yttrium-tungstenate (KLuₓY₁₋ₓW), and which serves as a mechanical mount for the first domain 22. In addition, the second domain 24 serves as an index matching medium for the purpose of reducing losses caused by ASE (amplified spontaneous emission).

With respect to the reduction of losses caused by ASE reference is made to U.S. Pat. No. 6,347,109, the contents of which are incorporated herein by this reference.

On the side that faces away from the second domain 24 the first domain 22 is equipped with numerous reflectors 26 that are aligned in sheet-like layers on top of one another, whereby (1) these reflectors 26 are made alternatively from KYW and KYbW and (2) the relatively great difference in the refractive indexes of KYW and KYbW is exploited. If the reflection of the reflectors 26 is insufficient, a dielectric reflector 28 can be provided on the side of the reflectors 26 that faces away from the first domain 22. Because only some of the required total reflection must be provided by reflector 28, reflector 28 can be configured to be particularly thin, which significantly reduces its thermal resistance.

In this way a high-performance disk laser that is simple and inexpensive is achieved.

FIG. 7 depicts an additional embodiment of an inventive solid body which has a first domain 32 including KYbW. The solid body also has a second domain 34 including KYW. In this embodiment the solid body forms a distributed Bragg reflector, in which a modulation of the complex refractive index has a real part as well as an imaginary part.

The inventive solid body can be used in numerous ways. The inventive solid body is particularly advantageous for laser uses, for example, for chip lasers without adaptive optics, ultra thin disk lasers for single frequency operation at particularly high performance, planar waveguide lasers and high-performance lasers without losses due to ASE.

In particular, the inventive concept makes achievement of thin disk lasers possible, because based on the particularly small absorption length, for instance, of KYbW a single pass through of the pumped beam through the laser active domain is sufficient. Consequently, expensive arrangements that are necessary with respect to conventional disk lasers in order to pass the pumped beam through the laser medium several times are no longer required.

The passive domain provided in the case of certain embodiments can serve as the mechanical mount for a laser active domain for controlling or adapting the refractive index or for generating a high cubic non-linearity.

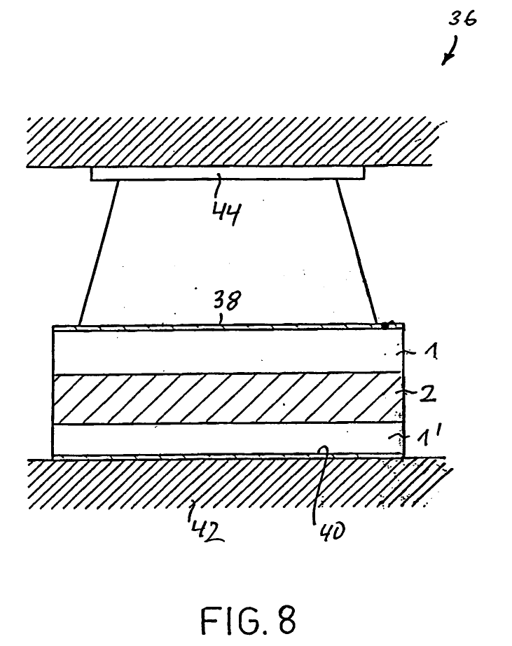

FIG. 8 depicts an embodiment of an inventive short pulse laser 36 that has an inventive solid body that is formed in multiple layers in this embodiment and has a laser active domain 2 that is sandwiched between two passive domains 1 and 1′. Coatings 38 and 40 are attached to the surfaces of the passive domains 1 and 1′ that face away from the laser active domain 2. A cooling device 42 is provided for cooling the solid body; it is attached to the surface of the coating 40 that faces away from the passive domain 1′. A laser diode 44 that emits the pump beam into the laser active domain 2 is provided in this embodiment for pumping the laser active domain 2 of the solid body.

Reflector mirrors that are not shown in the drawing may be provided in order to form a laser resonator, between which the laser beam oscillates during operation of the short pulse laser 36. In order to minimize the number of components and thus the costs of fabrication of the short pulse oscillator, it is expedient that the reflector mirrors be attached directly to the end surfaces of the solid body, for example, by means of vapor deposition.

The arrangement depicted in FIG. 8 makes possible amplification of the laser beam by a single or multiple pass-through of the laser beam through the laser active domain 2. Additional reflector mirrors are basically not necessary for this purpose.

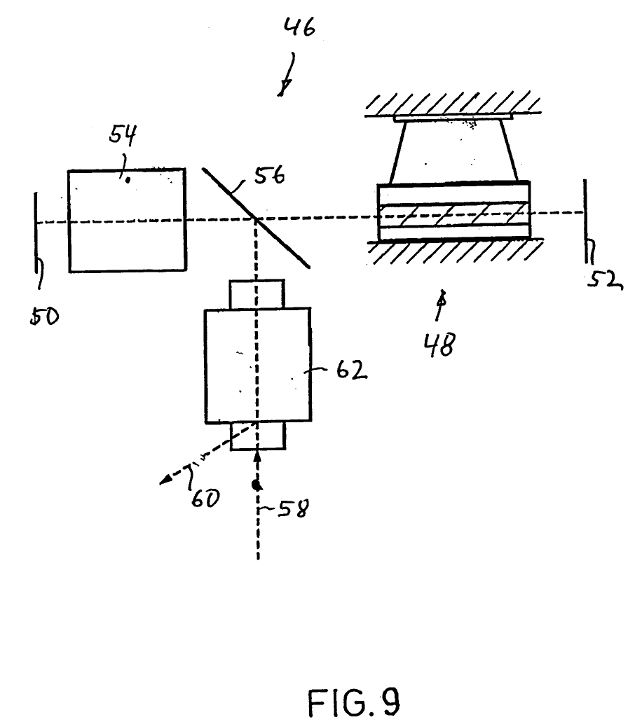

FIG. 9 depicts an embodiment of an inventive device for amplifying a laser beam which is designed in this embodiment as a regenerative amplifier 46. The regenerative amplifier 46 has as a means of amplification a solid body 48 which can, for example, be constructed like the solid body depicted in FIG. 8. The regenerative amplifier 46 has a laser resonator between whose resonator reflector mirrors 50 and 52 the solid body is arranged as a means of amplification. The regenerative amplifier 46 also has an optical switch 54 and a polarizing beam distributor 56, whereby the optical switch 54 serves to decouple a pulse or string of pulses that is/are amplified in the laser resonator, as soon as a desired amplification is achieved. An optical isolator 62 is provided to separate a laser beam 58 that is to be amplified from the amplified laser beam 60. Because a person having ordinary skill is already familiar with the construction and operation of regenerative amplifiers, they will not be discussed in detail here.

The inventive solid body makes it possible to achieve a regenerative amplifier in a simple and cost effect manner.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A solid body, comprising:
a) an optically used area;
b) the optically used area including monoclinic elementary cells;
c) the solid body, at least in the optically used area, is based on the same crystallographic system of coordinates;
d) at least two domains are provided in the optically used area of the solid body, and the at least two domains differing with respect to their chemical compositions; and
e) the optically used area including at least one active zone and at least one non-active zone.

2. A solid body as in claim 1, wherein:
a) at least in the optically used area, at least one of tungstenate, potassium, and rubidium is a constituent of the monoclinic elementary cells.

3. A solid body as in claim 2, wherein:
a) at least in the optically used area, at least one of Y, Sm, Eu, Gd, Tb, Dy, Ho, Er, Tm, Yb, and Lu is a constituent of the monoclinic elementary cells.

4. A solid body as in claim 3, wherein:
a) at least in the optically used area, at least one element from the group La, Ce, Pr, Nd, and Pm is a substitute for the at least one of Y, Sm, Eu, Gd, Tb, Dy, Ho, Er, Tm, Yb, and Lu.

5. A solid body as in claim 1, wherein:
a) the optically used area consists of one of KYb(WO₄)₂ and Yb substituted KYb(WO₄)₂, and the substituted one of KYb(WO₄)₂ and Yb substituted KYb(WO₄)₂ includes a low temperature modification.

6. A solid body as in claim 1, wherein:
a) a change in the chemical composition between the at least two domains runs in a single direction.

7. A solid body as in claim 1, wherein:
a) at least one element X from the group Y, Gd, Lu in the composition KₓRb_{y}X(WO₄)₂ is contained in the non-active zone of the optically used area, with x=0−1, y=1−0, and y+x=1.

8. A solid body as in claim 7, wherein:
a) the composition is one of KX (WO₄)₂, KₓRb_{y}X (WO₄)₂, and RbX(WO₄)₂, with x=0−1, y=1−0, and y+x=1.

9. A solid body as in claim 1, wherein:
a) the active zone includes LnₓKYb_{y}(WO₄)₂, Ln is at least one element from the group Y, Sm, Eu, Gd, Tb, Dy, Ho, Er, Tm, Yb, Lu, with x=0−1, y=1−0, and x+y=1.

10. A solid body as in claim 9, wherein:
a) REₓKYb_{y}(WO₄)₂ includes one of REK (WO₄)₂, REₓKYb_{y}(WO₄)₂, and KYb(WO₄)₂, with x=0−1, y=1−0, and x+y=1.

11. A solid body as in claim 1, wherein:
a) the solid body includes areas with substituted atoms which have been formed by one of molecular beam epitaxy, liquid epitaxy, hydrothermal breeding, CVD, sputtering, and diffusion bonding.

12. A solid body as in claim 11, wherein:
a) the areas with substituted atoms include layers, the layers being substantially 30 μm to 50 μm thick.

13. A device for generating coherent electromagnetic radiation including a solid body as in claim 1.

14. Method of using a solid body as in claim 1 as one of a disk and a chip laser.

15. Method of using a solid body as in claim 1 as one of a wave guide, a reflector mirror, and a Bragg reflector.

16. Method of using a solid body as in claim 1 as a wave guide, the wave guide including reflector mirrors configured as Bragg reflectors.

17. A device for amplifying coherent electromagnetic radiation including an amplifier, the amplifier having a solid body as in claim 1.

18. A device as in claim 17, the device is configured to amplify pulsed electromagnetic radiation.

19. A device as in claim 17, wherein the amplifier includes a regenerative amplifier.

20. A device as in claim 17, the amplifier is located inside a resonator.

21. A device as in claim 17, wherein the amplifier is located outside a resonator.

22. A device as in claim 13, wherein the coherent electromagnetic radiation includes a laser beam.

23. A solid body as in claim 4, wherein:
a) the optically used area consists of one of KYb(WO₄)₂ and Yb substituted KYb(WO₄)₂, and one of the Yb substituted KYb(WO₄)₂ and the KYb(WO₄)₂ includes a low temperature modification.
